(19) United States
(12) Patent Application Publication
(10) Pub. No.: US 2006/0172710 A1
(43) Pub. Date: Aug. 3, 2006

(54) Phase sweeping methods for transmit diversity and diversity combining in bts sector extension and in wireless repeaters

(75) Inventors: David Cahana, Haifa (IL); Gideon Argaman, Kiryat Tivon (IL); Joseph Shapira, Haifa (IL); Shmuel Miller, Doar-Na Oshrat (IL)

Correspondence Address: Martin Moynihan;Anthony Castorina, 2001 Jefferson Davis Highway, Suite 207, Arlington, VA, 22202, US

(73) Assignee: Celletra Ltd., Yokneam llit (IL)

(21) Appl. No.: 10/548,375

(22) PCT Filed: Mar. 25, 2004
(86) PCT No.: PCT/IL04/00274

§ 371 Date: Sep. 7, 2005

Related U.S. Application Data
(60) Provisional application No. 60/457,331, filed on Mar. 26, 2003.

(51) Int. Cl. H04B 1/02; H04B 7/02

(52) U.S. Cl. 455/101

(57) ABSTRACT

Apparatus for inserting transmit diversity into an RF signal for transmission, comprises: an RF splitter for splitting the RF signal to be transmitted into two signal parts, and a non-linear phase modulator which applies a non-linear phase modulation to one of the two signal parts, thereby to provide transmit diversity between the first signal part and the second signal part. One of the ways of inserting a non-linear phase modulation into the RF signal is to use a spinning disc with tracks of different dielectric strength. The apparatus is useful in cellular telephony for supplying repeaters and base station extensions with diversity capability.

### FIELD AND BACKGROUND OF THE INVENTION

The present invention relates to phase sweeping methods for transmit diversity and diversity combining and, more particularly, but not exclusively to their use in cellular base station sector extension or modification constructions and in conjunction with wireless repeaters.

A repeater in a cellular communications network or for that matter a sector extension, receives a signal transmitted by a donor base station (BS) and retransmits it to the mobile subscriber (MSs) in the remote coverage area of the repeater after amplifying and perhaps filtering the signal. At the same time, the repeater receives signals transmitted by MSs in the remote coverage area of the repeater and retransmits them to the donor. Except for amplifying, filtering, and, in some systems, performing frequency conversion, repeaters do not typically process received signals, and indeed the baseband signal is not typically accessed at a repeater. The conduit between a repeater and a donor may be RF (radio frequency) over-the-air transmission, RF cable, or optical fiber.

The difference between a repeater and a base station extension is that a repeater repeats transmission by the base, that is both base and repeater transmit to mobile users and the repeater simply extends the coverage, while in the base extension case the base station, or at least the individual sector, transmits to mobile users only through the extension and not directly. That is the base station is in one location and the coverage area is elsewhere (remote).

Diversity techniques provide a powerful means of mitigating gain and phase fluctuations (“fading”) of the mobile channel. They are used in cellular and wireless access networks to enhance coverage and capacity. RF diversity techniques, such as space diversity, polarization diversity, and antenna pattern diversity, incorporate two or more antennas. On the receive side (“receive diversity”) each of the antennas receives the same transmission but in a different channel state. Thus, fading of a signal received by one antenna is assumed not to correlate with the fading of signals received by the other antenna(s). A diversity-combining system is then applied at the receiver of the base transceiver station (BTS) to optimally combine the diversity branches.

In the uplink direction (from MS to BS), repeaters need to relay two diversity branches back to the donor BTS such that the donor can resolve the branches. RF coax-supported repeaters typically require two separate coaxial cables to relay the diversity branches. Fiber-supported repeaters require two separate fibers (or two distinct waves), with respective converters or multiplexing systems, such as wave division multiplexing (WDM). Over-the-air RF transmission to the donor requires two separate transmission channels. Orthogonal polarization transmission has been proposed, as well as a time phase-shift modulation (“phase sweep”) of one of the two repeater antennas that transmit the diversity branches to the donor. Existing systems incorporate two transmit amplifiers and two transmission channels, which due to the cost of the amplifiers, impact the total cost of repeaters.

Time delay diversity combining has been applied to repeaters in order to reduce the number of transmission channels from the repeater to the donor. This method, which is suitable for certain CDMA (code-division multiple access) systems that apply “rake” receivers, makes use of an additional amount of absolute time delay in one of the diversity branches to resolve between the branches at the donor rake receiver, which then optimally combines them. This method adds additional interference to the donor receiver and generates twice the number of fingers ('delay responses) at the rake receiver.

Mobile stations for cellular communications and some other wireless access services are typically equipped with only one antenna and one receiver. Thus, they do not benefit directly from diversity reception, which effectively smoothes the downlink (BS to MS) channel. Transmit diversity (TD) is a method to provide diversity on the downlink by transmitting from two or more antennas, configured so that the fading of their transmission channels to the MS is not correlated with one another. This is a “blind” method, wherein the two transmissions are not dynamically adapted so as to optimally combine at the MS receiver. These transmissions need to be resolved by the MS receiver or by alternative mechanisms for diversity combining.

Known types of transmit diversity include phase sweeping transmit diversity (PSTD), time delay transmit diversity (TDTD), orthogonal code transmit diversity and STTD—Space-Time TD—a version of Orthogonal Code TD. PSTD is applicable to analog phase-modulated transmissions, as well as to digital modulations and CDMA. However, TDTD and orthogonal code TD are suitable for digital modulation only. TDTD is suitable only for those CDMA systems in which the MS receiver is equipped with a rake receiver. The TDTD and PSTD transmit diversity schemes do not require modifications in the MS receiver and do not require specification changes in any of the air interface standards and thus are easier to implement than orthogonal code TD, which is compatible with third generation systems (and beyond) only [e.g., CDMA2000 and WCDMA (Wideband CDMA) UMTS (Universal Mobile Telecommunications System)].

U.S. Pat. No. 5,652,765 by Adachi discloses a diversity arrangement in a repeater on both the uplink and the downlink. The arrangement includes a time delay unit within one of the diversity channels.

FIG. 1 (Prior Art) illustrates an arrangement for time delay receive diversity in an uplink. The signals from a single mobile station 2 in the coverage area of an RF repeater 4 are received in the mobile distribution side antennas 36, 37 of RF repeater 4. The received signals comprise two different signals 33, 34, which are then combined with equal gain after one of them has been delayed using delay unit 35. The newly combined signal is fed to a common RF amplifier 32 and transmitted to the BTS 1 through a common donor side antenna 31 of the repeater 4.

The two combined uncorrelated signals can be received at base station (BTS) 6 by either a single BTS antenna 11 or by two separate antennas 11, 12. Taking an example in which the base station is a CDMA base station, the time delay between the two signals allows the CDMA base station to receive each signal via a different correlator of its rake receiver. It then correctly diversity-combines the two signals by first properly adjusting their relative phase and amplitude, thus stabilizing the signal stream and reducing the fading.

FIG. 2 (Prior Art) illustrates an arrangement for time delay transmit diversity in a downlink. The BTS 6 transmits, from one antenna 51, a single downlink signal, which is received by a single donor side antenna 61 of the RF repeater 4. This downlink signal is firstly amplified by low noise amplifier (LNA) 62, and is then evenly split. One half is fed through a delay unit 63 into a diversity signal power amplifier 64, and the other half of the signal is input into a direct signal power amplifier 65. The two power amplifiers are preferably configured so that both signals have almost the same amplitude at the antennas 66, 67.

Antennas 66, 67 are e.g., spaced apart so that any fading generated at the mobile unit receiver from the transmission from one antenna will not be correlated with the fading generated from the transmission of the other. Alternatively, these antennas can have two different polarizations, and thus, the fading of their transmission will be similarly decorrelated. The time delay between the transmissions of the two antennas allows the CDMA mobile station to receive each signal via a different correlator of its rake receiver. It then correctly diversity-combines the two signals by first properly adjusting their relative phase and amplitude, thus stabilizing the signal stream and reducing the fading.

U.S. Pat. No. 5,930,293 to Light describes the use of RF domain delay diversity for CDMA Cellular networks. The disclosed delay unit is built by a length of transmission line or lumped circuits for one of the channels. The two diversity channels are then combined onto a single channel as is depicted in FIG. 1 therein.

U.S. Pat. No. 6,125,109 by Fuerter discloses combining the two receive diversity (uplink) branches of an RF repeater after one of the branches is delayed compared to the other and the gain is equalized. This delay and combining operation is carried out in the RF domain.

The summation of two equal-amplitude signals, differing slightly in frequency, creates a composite signal that fades periodically. However, if each of these signals individually suffers from multipath fading at a slower rate than the composite fading, the resulting composite signal smoothes the fading to a great extent. Since the fades of two signals are uncorrelated, then at each instant of time when one signal fades, the other signal dominates. Such a “phase sweeping” combination of fading signals may serve as a method for selective diversity combining.

Published PCT Application No. WO 98/39856 discloses a phase modulation diversity repeater. FIG. 3 (Prior Art) depicts an arrangement that includes such a repeater 4 and a BTS 6. Repeater 4 relays diversity signals received from mobile stations to the BTS donor antenna 11, that is, in the uplink direction. Repeater 4 includes two transmit antennas 21, 22 associated with main receive antenna 26 and diversity receive antenna 27, respectively. One of the diversity branches of repeater 4 includes a phase sweeping mechanism 25. Phase sweeping mechanism 25 shifts the signal frequency in the associated diversity branch by 50 to 100 Hz, for example. Repeater 4 includes two transmit amplifiers 23, 24 and two transmission channels, but this increases the complexity and cost of repeater 4.

The selective diversity combining provided by phase sweeping mechanism 25 may be especially effective when the channel fading is slower than the applied phase modulation. With a higher fading rate, the fading statistics of the composite signal approach that of each of the signals being processed by the respective diversity arms. For this reason, this method is beneficial mainly for slow moving mobiles. At higher speeds, an interleaver coder-decoder, which is incorporated in many digital wireless communications systems, may act as a time diversity mechanism and smooth the fading channel.

The generation of a frequency shift generally requires a separate RF generator for each of the two transmit antennas 21, 22, and separate generators for each radio carrier frequency in a multicarrier transmission. The repeater of FIG. 3 does not require two separate RF sources per channel, but performs RF phase modulation simultaneously on all the carriers.

A literature search reveals that there has been substantial work on so-called blind phase modulation transmit diversity. The main objective is to avoid deep fades by artificially varying the phase between two simultaneous transmissions of the same information. The basic phase modulation case that is treated in the published literature is the linear phase sweep, which lends itself to implementation by slight frequency shifting of one transmit branch with respect to the other. The slight frequency shifts employed (of the order of ±50 Hz) do not violate the frequency accuracy requirements for regulatory approval of the cellular transmitted signal. A short representative list of publications is:

“Orthogonal polarization and time varying offsetting of signals for digital data transmission or reception,” Michael J. Gans, Vijitha Weerackody, Jack Harriman Winters, Lucent Technologies Inc., U.S. Pat. No. 5,943,372 filed Jun. 23, 1997.

“An introduction to PSTD for IS-95 and cdma2000,” A. Gutierrez, J. Li, S. Baines, D. Bevan (Nortel Networks), 1998

“Combined effects of phase sweeping transmitter diversity and channel coding,” A. Hiroike, F. Adachi, N. Nakajima, IEEE VT-41, May 1992, pp. 170-176.

“Design and analysis of transmitter diversity using internal frequency offset for wireless communications,” W-Y Kuo, M. P. Fitz, IEEE VT-46, November 1997, pp. 871-881.

The contents of each of the above-cited documents are hereby incorporated herein by reference.

The phase modulation case treated in the published literature is linear phase swept transmit diversity. It is shown to provide a diversity gain that depends on speed, with a gain of 4.8 dB at low-speed. It will be appreciated that the gain may increase to ∞dB, when the mobile unit is stationary and in a deep fade. Generally the phase modulation diversity is inferior to Time-Delay Diversity by 1-2 dB. Its benefit increases with sweep rate in the range of 50-100 Hz, and for slowly moving mobile users. With various coding schemes, it depends on the forward error correction (FEC) employed, as well as on the interleaving characteristics. The 1992 Paper (Adachi et. al.) presents relationships between the coding and interleaver parameters, and the sweep rate and required phase deviation. The relationships are specifically for a sinusoidal phase sweep.

There is thus a widely recognized need for repeaters and remote sector extensions. and it would be advantageous to have an efficient and inexpensive way of implementing transmit and receive diversity repeaters and base extensions.

### SUMMARY OF THE INVENTION

According to one aspect of the present invention there is provided apparatus for inserting transmit diversity into an RF or IF signal for transmission, comprising:

an RF splitter for splitting said signal for transmission into two signal parts, and

a non-linear phase modulator, associated with said RF splitter, for applying a non-linear phase modulation to one of said two signal parts, thereby to provide transmit diversity between said first signal part and said second signal part.

Preferably, said non-linear phase modulator comprises a transmission line with variable dielectric loading.

Preferably, said non-linear phase modulator is configured to provide a modulation being one of a group comprising sinusoidal, ramp, triangular and square wave modulation.

Preferably, said non-linear phase modulator is configured to provide two-step phase modulation.

In an embodiment, said non-linear phase modulator is configured to provide four-step phase modulation.

In an alternative embodiment, said non-linear phase modulator is configured to provide eight-step phase modulation.

Preferably, said non-linear phase modulator comprises a delay line.

Preferably, said delay line is any of: lengths of conducting material, lengths of coaxial cable, lengths of strip line, lengths of microstrip, a lumped delay line, surface acoustic wave filters (SAWs), a tri-plate transmission line with variable transmission loading, a disc constructed from a tri-plate transmission line with variable transmission loading, and a plurality of discs constructed from tri-plate transmission lines with variable transmission lines.

Preferably, said non-linear phase modulator comprises a tri-plate transmission line with variable transmission loading.

Preferably, said variable transmission loading is a periodically variable dielectric loading.

The apparatus is preferably configured to apply said variable loading synchronously to respective paths of each of said first and second signal parts.

Preferably, the tri-plate transmission line is configured with an effective dielectric constant and an electrical length to provide a periodic 360° phase sweep.

Preferably, said variable dielectric loading is provided using an alumina dielectric.

Preferably, said non-linear phase modulator comprises at least one rotatable disc with a spiral pattern of variable dielectric loading.

The apparatus may comprise a motor for rotation of said disc.

Preferably, said non-linear phase modulator is combined with a power amplifier by feeding an RF signal to which said non-linear phase modulation has been applied, as an amplifier drive signal.

Preferably, said spiral pattern comprises a bi-phase spiral.

Preferably, said non-linear phase modulator further comprises a butterfly dielectric disc with two bi-phase spirals.

Preferably, said non-linear phase shifter is connected at a low power section of said apparatus and is followed by an amplifier for amplifying said signal part for transmission.

Preferably, said non-linear phase shifter is located at a high power section of said apparatus to apply a non-linear phase shift to said signal part at a transmission power level.

The apparatus may comprise a signal combiner for combining said signal parts into a single signal for transmission in a single channel.

The apparatus may have a first link direction and a second link direction, said splitter and said non-linear phase modulator being for transmission in a single channel in said first link direction and a second non-linear phase modulator being followed by a combiner for transmission in said second link direction.

The apparatus may be incorporated into a repeater, a cellular base station external upgrade, or a cellular base station extension.

The apparatus may comprise a repeater for extending the coverage of a base station or base station sector.

Preferably, said non-linear modulation provides space diversity.

Alternatively or additionally, said non-linear modulation provides polarization diversity.

Preferably, transmission is in slots and wherein each slot is assigned to an individual recipient. The slot assignment is useful for high data rate transmission, for example in 1xEVDO.

The apparatus may comprise bandwidth assignment logic configured such that a number of slots assigned to any given recipient is dynamically controlled in response to transmission quality associated with said recipient.

The apparatus may comprise modulation parameter logic for dynamically altering parameters for said non-linear phase modulation in accordance with a number of recipients currently connected.

Preferably, said non-linear phase modulator is configured to suspend modulation when a number of currently connected recipients falls to one.

According to a second aspect of the invention there is provided a phase modulating element for modulating an RF or IF frequency, comprising:

first and second movable dielectric plates,

first and second ground lines located in between said first and second movable plates, and

a strip line located in between said first and second ground lines,

said movable dielectric plates and said strip line forming a tri-plate variable dielectric transmission line to provide a non-linear modulation.

The element may be configured as a rotatable disc.

Preferably, variable dielectric regions are placed thereon as at least one spiral.

According to a third aspect of the present invention there is provided a method for inserting transmit diversity into an RF or IF signal for transmission, comprising:

splitting said signal for transmission into two signal parts, and

applying a non-linear phase modulation to one of said two signal parts, thereby to provide transmit diversity between said first signal part and said second signal part.

The method may comprise carrying out said inserting in each of two transmission directions, and in one of said directions combining said first and second signal parts onto a single channel. Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 (Prior Art) illustrates an arrangement for time delay receive diversity.

FIG. 2 (Prior Art) illustrates an arrangement for time delay transmit diversity.

FIG. 3 (Prior Art) depicts an arrangement that includes a phase modulation diversity repeater.

FIG. 4 is a simplified diagram illustrating a phase modulation transmit diversity in the downlink according to a first preferred embodiment of the present invention.

FIG. 5 is a simplified diagram illustrating a bi-directional repeater which carries out phase modulation transmit diversity in the downlink according to the embodiment of FIG. 4 and which combines the main and diversity receive signals onto a single channel for uplink transmission to the base station

FIG. 6 illustrates a wireless RF repeater that provides uplink PM diversity combining according to an embodiment of the present invention.

FIGS. 7A-7E illustrate performance of an embodiment employing sinusiodal phase modulation.

FIG. 8A illustrates an analog phase shifter for generating a phase sweep according to an embodiment of the present invention.

FIG. 8B illustrates a digital phase shifter for generating a phase sweep according to an embodiment of the present invention.

FIG. 8C is a simplified diagram illustrating an analog phase shifter;

FIG. 9 illustrates a wireless RF repeater that provides downlink PMTD according to an embodiment of the present invention.

FIG. 10 illustrates a fiber optic repeater that provides uplink PM Diversity combining according to an embodiment of the present invention.

FIG. 11 illustrates a fiber optic repeater that provides downlink PMTD according to an embodiment of the present invention.

FIG. 12 illustrates a fiber optic repeater that provides uplink time delay diversity combining according to an embodiment of the present invention.

FIG. 13 illustrates a fiber optic repeater that provides downlink time delay diversity according to an embodiment of the present invention.

FIG. 14A illustrates a prior art Time Delay transmit diversity approach.

FIG. 14B-14C illustrate PMDU transmit diversity augmentation embodiments for a legacy base station or a high-power repeater.

FIG. 15 illustrates a dielectrically-loaded stripline implementation of the PMDU.

FIG. 16 illustrates a microwave circuit layout for an embodiment of the PMDU.

FIG. 17 illustrates a CAD model of an embodiment of a 1.9 GHz PMDU.

FIG. 18 illustrates the phase shifter insertion loss of main and diversity paths of the 1.9 GHz PMDU.

FIG. 19 illustrates the differential phase performance of the 1.9 GHz PMDU.

FIG. 20 illustrates an embodiment of Polarization Diversity employing the PMDU.

FIG. 21 is a simplified diagram illustrating surface patterning on a phase modulation disc according to a preferred embodiment of the present invention.

FIG. 22 is a simplified diagram illustrating alternative surface patterning on a phase modulation disc according to a preferred embodiment of the present invention, and

FIG. 23 is a simplified diagram illustrating yet another embodiment of surface patterning on a phase modulation disc according to a preferred embodiment of the present invention.

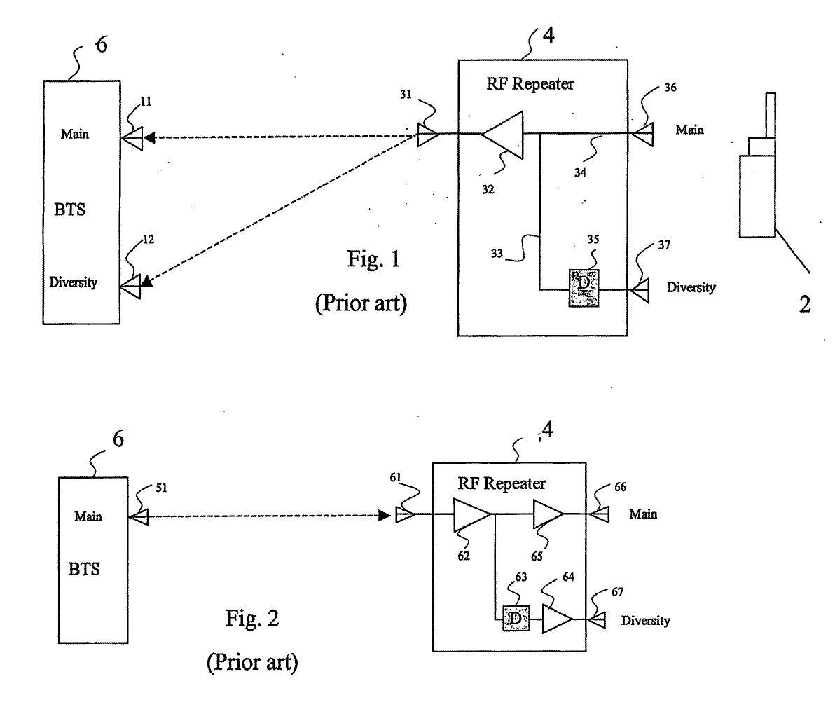

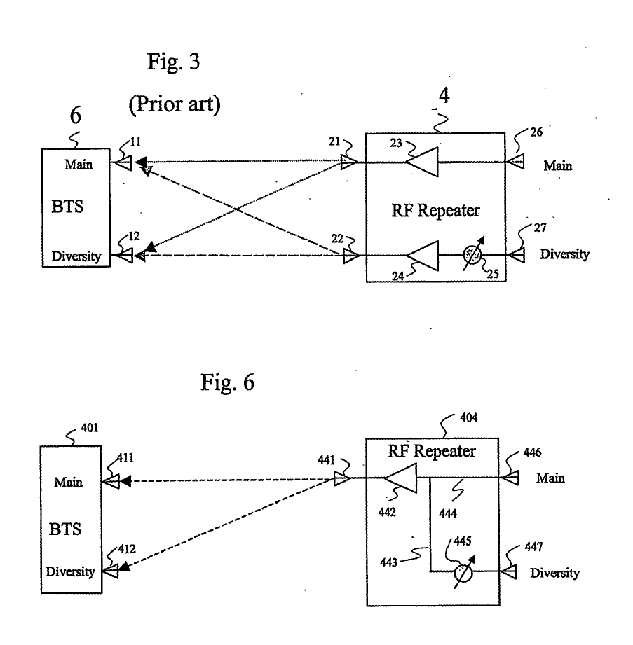

### DESCRIPTION OF THE PREFERRED EMBODIMENTS

The present embodiments provide for a repeater (or base station extension) in a wireless communications network that is capable of transmit and receive diversity communication with the mobile subscriber, while maintaining a single transmit and receive link with the base station. This is accomplished by using non-linear phase sweeps in the downlink (for generating the transmit diversity) and in the uplink for diversity combining. Furthermore, the present embodiments focus on systems and methods of implementing a phase sweep for receive signal diversity combining and for transmit diversity which employ means for generating the phase sweep function in either the RF or IF part of the signal flow, and on generalizing the phase modulation. When implemented as a transmit diversity embodiment, it is referred to as PMTD (Phase Modulation Transmit Diversity). This method of transmit diversity is less complex and should be less costly to apply than prior art approaches, while operating simultaneously on multiple carriers.

In an embodiment for the uplink, the repeater includes receive diversity antennas through which to receive RF (radio frequency) signals. Each of the receive signals is associated with a respective receive signal path. A phase sweeping mechanism in the repeater applies a phase sweep to one of the receive signals. A combiner in the repeater combines signals conveyed along the respective receive signal paths and produces a combined signal. A transmission mechanism transmits the combined signal over a transmission link, such as an over-the-air, cable, or fiber link.

In an embodiment for the downlink, the repeater includes a receiver to receive a downlink signal over a link. A splitting mechanism in the repeater splits the receive signal into at least two transmit signal paths. A phase sweeping mechanism applies a phase sweep to a signal conveyed along one of the transmit signal paths, and the phase sweep is preferably non-linear as explained. A transmission mechanism transmits respective RF signals conveyed along at least two transmit paths. An example of a phase sweeping mechanism used in the present embodiments is a rapidly rotating disc having different dielectric strength regions patterned over it.

In alternative embodiments, the repeater includes time delay elements in lieu of phase sweeping mechanisms.

In the case of an upgrade to an existing base station upgrade, including augmentation thereof, the preferred embodiment comprises adding transmit diversity by modifying only the downlink, that is the link from the base station to the mobile units. The downlink signal is split into two, and non-linear phase modulation is added to one of the signal branches. Both branches are then transmitted to provide a transmit diversity. However, the modification is made at high power using a high power phase modulator, so that only one power amplifier is needed, and the modification to the legacy base station itself is minimal. In particular there is no need to obtain access to the baseband signal.

It is possible to use a differential phase shifter on both signals.

Embodiments of the present invention are directed to a system and method for generating diversity in wireless repeaters. In uplink and downlink embodiments, a phase sweeping mechanism is employed in a repeater to generate diversity. The repeater may be linked to a base station via a single wireless link, an RF cable, or an optical fiber transmission system.

In uplink embodiments, two or more different samples of a signal received through two or more diversity antennas are combined into one signal at the repeater. The signal is then relayed to a donor base station.

In downlink embodiments, a signal received from a base station is split at a repeater into diversity branches and relayed to a mobile station.

In accordance with embodiments of the present invention, repeaters constructed and operating in accordance with the disclosed embodiments may process multi-carrier signals simultaneously. It should be understood that principles explained herein with respect to a repeater apply mutatis mutandis to base station or sector remote extensions.

The principles and operation of a diversity based wireless system according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

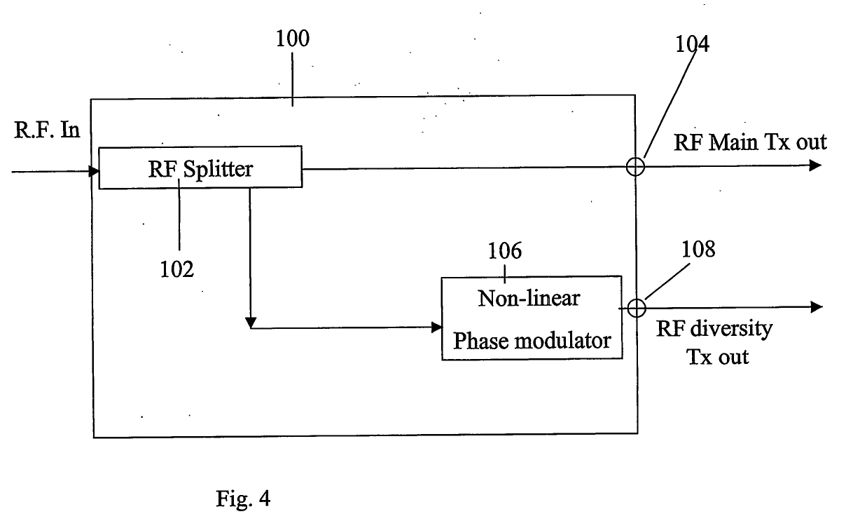

Reference is now made to FIG. 4, which illustrates a generalized embodiment of the present invention. Phase modulation apparatus 100 inserts transmit diversity into an RF signal for transmission. The input to apparatus 100 is the RF signal, or alternatively an IF (intermediate frequency) signal. The input goes to an RF splitter 102 which splits the signal for transmission into two signal parts. One of the parts is fed straight to transmit output 104 as is to provide the main transmit signal. The other part is fed to non-linear phase modulator 106 which applies a non-linear phase modulation thereto to provide a phase modulated signal part for the transmit diversity signal. The resulting diversity signal is fed to diversity output 108 of the apparatus 100. The non-linear modulation provides transmit diversity between the two signal parts. In the receiver the two signals are combined onto a single channel and overcome multipath fading.

In one embodiment, the non-linear phase modulator 106 comprises a transmission line with variable dielectric loading. In another preferred embodiment the non-linear modulation is two-step phase modulation. In another preferred embodiment the modulation is four-step phase modulation and in a particularly preferred embodiment the modulation is eight-step phase modulation.

A preferred embodiment of the non-linear phase modulator 106, suitable for high power RF phase modulator, comprises a tri-plate transmission line with variable transmission loading. Preferably, the variable dielectric loading in the disc is provided in the form of a spiral pattern of variable dielectric loading printed or otherwise located onto the disc. A variety of wave-shapes (phase sweep patterns) is realizable by properly shaping the disk and line patterns. The disc embodiments are described in greater detail below.

In order to provide effective phase modulation at the necessary frequencies the disc has to spin at relatively high speeds. However the rotation speed can be reduced by using two bi-phase spiral in series, with a ‘butterfly’ dielectric disk, as will be explained in greater detail below.

In one embodiment, the non-linear phase modulator 106 is connected at a low power section of apparatus 100 and is followed by an R.F. amplifier for amplifying the signal part or parts for transmission. Alternatively, the non-linear phase modulator 106 is located at a high power section of apparatus 100 to apply a non-linear phase shift to the signal part at a transmission power level. In a particularly preferred embodiment described in greater detail below, a non-linear phase modulated signal is used as the control input to the R.F. amplifier. The result is a combined modulator and amplifier device, and the use of a single combined device contributes to overall efficiency.

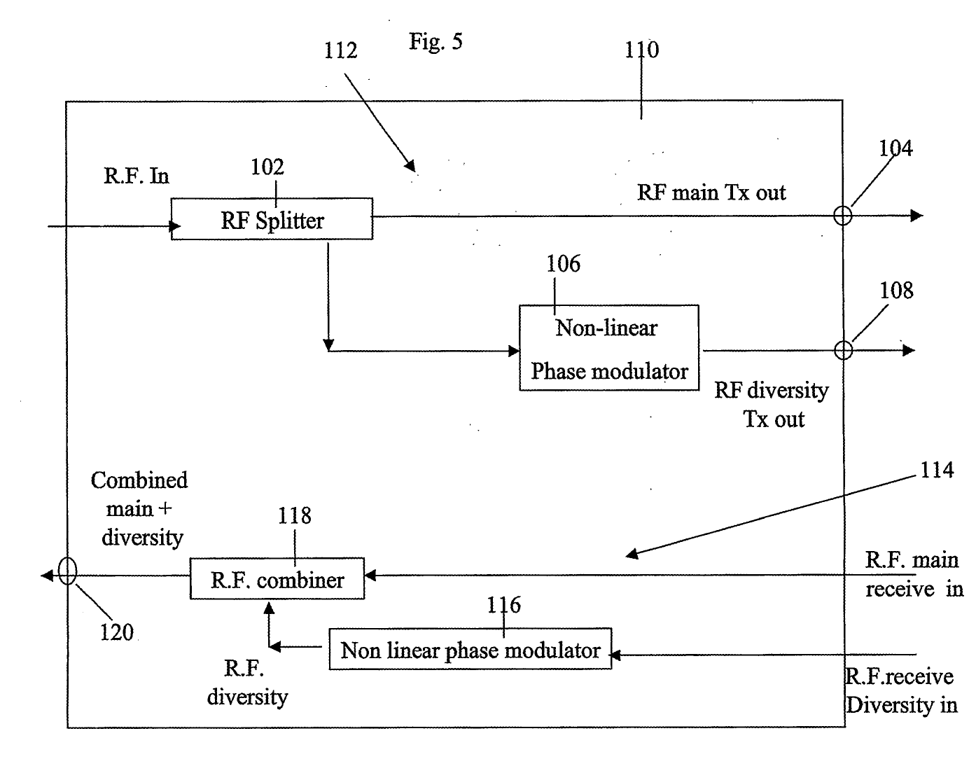

Reference is now made to FIG. 5, which shows a bi-directional R.F. transmit apparatus 110 comprising a downlink 112 which provide transmit diversity and an uplink 114, which provide diversity combining, both of which use non-linear phase modulation in accordance with the preferred embodiments of the present invention. Parts that are the same as in previous figures are given the same reference numerals and are not referred to again except as necessary for understanding the present embodiment.

In uplink 114 the input signals are the main and diversity received signals which are received separately. The receive diversity signal is fed to an uplink non-linear phase modulator 116 which introduces a non-linear phase shift identical to that described above. Then both the phase shifted diversity signal and the main receive signal are supplied to a signal combiner 118 which combines the two signals onto a single channel for output via terminal 120.

Apparatus 110 can be used for example as a repeater or base extension for a cellular network. In such a case the uplink 114 is the link from the repeater to the base station and the downlink is to the individual mobile units. The same non-linear phase modulation can be used to augment a legacy base station with transmit diversity. Since apparatus 100 (see FIG. 4) operates on the RF (or IF) frequencies, the modification does not require accessing the baseband signal and thus is simple and convenient.

In the following, more detailed explanations are given for specific embodiments of a wireless repeater, fiber repeaters and extensions, followed by a discussion of different embodiments of the phase modulator. In addition an embodiment of a combined modulator and RF amplifier is discussed and an embodiment in which adaptive modulation is used to assign bandwidth on the basis of SNR to individual mobile units.

Wireless Repeater

Uplink Diversity Combining

FIG. 6 illustrates an RF repeater 404 that implements phase modulation diversity combining according to an embodiment of the present invention. A base station (BTS) 401 includes main receive antenna 411 and diversity receive antenna 412. Repeater 404 includes two or more diversity antennas 446, 447 that receive diversity uplink transmissions from the mobile station (MS) in the remote coverage area of the repeater.

Repeater 404 includes a phase sweeping device 445 in one of the diversity branches to modulate the signal conveyed through the branch adapted for reception by one of the two (or more) diversity antennas 46, 47. The phase sweeping unit 445 in the present embodiment has zero gain, which ensures that the level of the signals in the direct and diversity signal branches is the same. Branches 443, 444 are combined to form a combined signal, which is input to an amplifier 442. After amplification, the signal is conveyed to a single donor side antenna 441 of the RF repeater 404 and transmitted to the receive antennas 411, 412 of the donor. This combined signal has the smoothing effect on the fading as described above. The configuration shown in FIG. 6 can be applied to any type of modulation and air interface, with proper choice of modulation parameters.

Adaptive Phase Sweep Generation in the RF or IF Stream

Various methods may be employed to generate the phase sweep (PS) provided by phase sweeping unit 445 in repeater 404. It is to be appreciated that phase sweeping transmit diversity (PSTD) is not limited to CDMA signals. For instance, PSTD may apply to various air-interface types, such as TDMA (time division multiple access) types of cellular communications systems (e.g., IS-136, PDC, GSM), as well as CDMA (IS-95, CDMA2000, UMTS). PSTD may have comparable, and sometimes superior performance, to that of time delay transmit diversity (TDTD). The phase sweep may be generated at RF or IF (intermediate frequency) in various embodiments.

Combining two signals that differ slightly in frequency creates an amplitude-modulated signal that fades periodically. This effect may be implemented by the generation of two separate carrier signals. Such a phase sweep can be applied in RF only as in the e.g., “serrodyne,” approach, that is, employing a linear sawtooth phase modulation. A possible difficulty with employing and implementing this modulation is the abrupt change from one sweep to the next, which generates wide band spurious modulation. Such effects can be tolerated in some systems, but may be harmful in other cases.

Several alternative modulation formats may be employed for the swept phase modulation. These include sinusoidal phase modulation, square phase modulation, triangular phase modulation, and discrete uniform phase modulation (2-step, 4-step, and 8-step), covering 180° or 360°. The relative performance may be compared for various system needs. One preferred embodiment (identified to be highly advantageous as a result of one comparison) was the 8-step phase modulation, spanning 360° with eight uniform 45° steps.

The phase modulation formats (PM cases) considered in a comparison were the following:

Standard or prior art Linear Phase sweep, which corresponds also to a small frequency shift between the main and diversity channels. This serves also as a reference case for the other cases.

Sinusoidal wave phase modulation (over 180° or 360°)

Triangular wave phase modulation (over 180° or 360°)

Ramp wave phase modulation (over 180° or 360°); the 360° case ideally is the same as linear phase sweep.

Square wave phase modulation (over 180° or 360°); this is also termed 1-bit PM

2-bit (4-state) discrete phase modulation (over 180° or 360°)

3-bit (8-state) discrete phase modulation (over 180° or 360°)

Computer simulations were performed to determine and compare key performance aspects. The simulation of two channels involved employing independent Rayleigh fading, random fixed phase Ψ between the two channels, Doppler for 850 MHz with 2.5 km/h speed and phase sweeping one channel before combining them. By properly setting the phase modulating function and the weight of the branches, the following results were obtained for a single branch, maximal-ratio-combiner (MRC). This performance represents an upper bound for TDTD performance, and the various cases of PMTD.

In all cases the CDF (cumulative density function) of the envelope was analyzed with respect to the single branch envelope CDF. This provides a measure for the diversity gain. In addition, the ≦−10 dB fade duration histogram and relative duration over time (duty ratio—DR) in % were analyzed per case. The smaller the DR % and the maximum value of fade duration, the better the operation of the de-interleaving and decoding functions. The single and two-branch MRC envelope CDF's were also analyzed as a sanity check of the simulation tool, to compare with well-known results from the published literature. It was observed that Ψ° values around 90° are best with 0°/180° switching, since the two Rayleigh modulated signals are then orthogonal. It was further checked and verified that Ψ° values at 180° are similar to those at 0° in performance. It was also observed that the bi-phase PM decreases the fade duration T and duty ratio DR % but maintains a trail of events, which are not of diminishing probability, and have much longer T (700) and DR (35%) values. A summary of the results of this comparison is shown in Table 1.

Based on the comparative simulations, with the linear phase modulation serving as a benchmark, the 360° 8-step phase modulation performance is apparently the most advantageous out of the discrete phase shift schemes considered. The realization employs a 3-bit relative phase shift between the two branches, which may be split between the two branches with a 2-bit phase shift network. Thus, the losses may be minimized, and the two branches balanced. Various alternative embodiments employ M-Phase Steps over 360°, such as 4-step (2-bits), 8-step (3-bits), etc. for PSTD realization. The quality of 8-step PSTD is close to that of linear sweep PSTD. In realizing a 100 Hz control signal that steps the phase of one branch with respect to the other branch, 45° steps or finer steps may be alternatively employed. Table 1 summarizes the different phase modulations that were tested and the results received.

TABLE 1
Summary of modulations tested

| | | | | −10 dB | −10 dB | |
|---|---|---|---|---|---|---|
| No. | Diversity Unit Type | Div. Gain (@ 0.1) | | Fade T | DR % | Comments |
| 0 | IDA | +6.2 | dB | 800 | 0.64 | Absolute Reference |
| 1 | Single Branch | 0.0 | dB | 1000 | 7.2 | Starting Case |
| 2 | 4-steps of 45° | −7 to +6.2 | dB | 30 | 20.2 | Performance function of (ψ) |
| 3 | 5-steps of 45° | −4 to +6.1 | dB | 30 | 17 | Performance function of (ψ) |
| 4 | 8-steps of 45° | 0 | dB | 25 | 10.6 | Not Far from Ref. PM |
| 5 | Linear Phase Sweep | 0 | dB | 8 | 12.5 | Reference PM |
| 6 | 2-steps 0°/180° | −12 to +3 | dB | 700 | 35 | For worst case ψ |

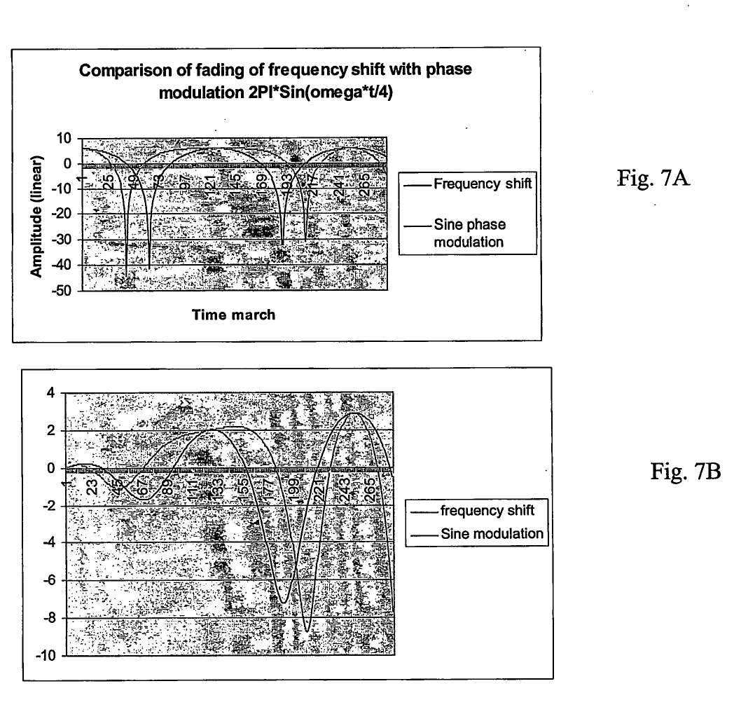

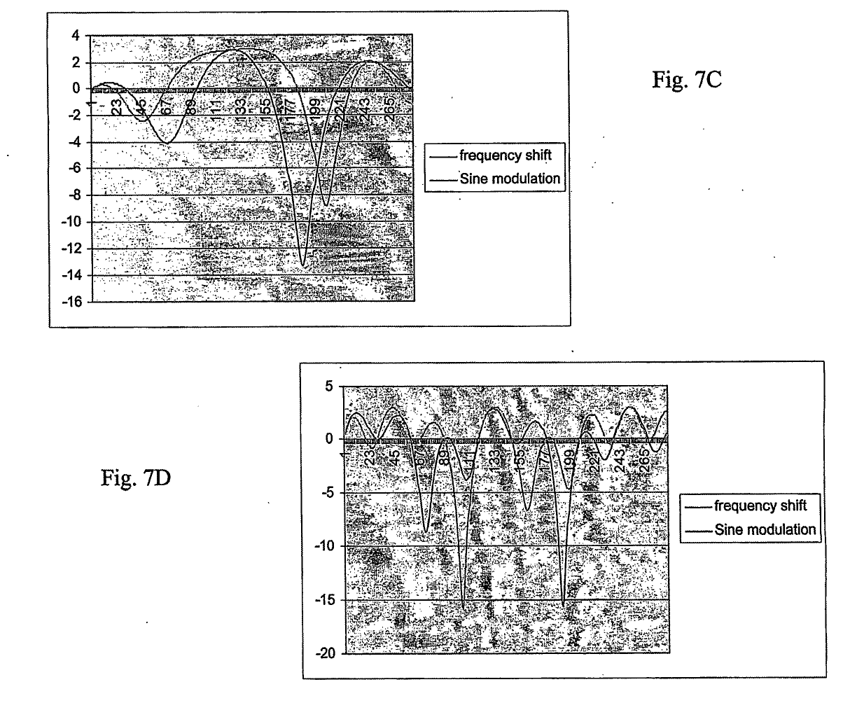

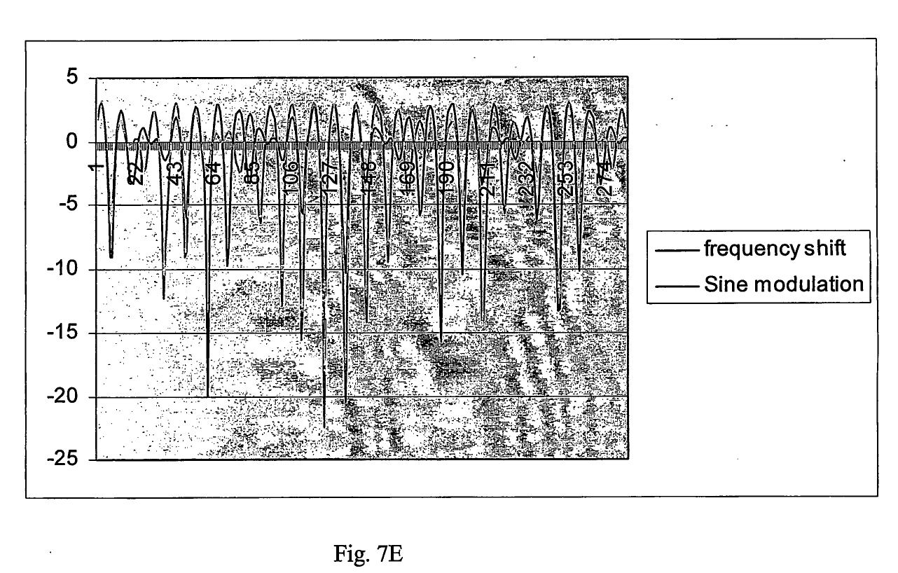

All the above-mentioned forms of phase modulation were also implemented in hardware and experimented with on CDMA signals in a laboratory test set-up. The preferred embodiment of 8-step phase modulation was verified also in the hardware implementation as the one with best performance. An alternative modulation is Sinusoidal modulation. Proper choice of the amplitude and frequency of this modulation creates a wave shape that is similar to that of the PS without generating discontinuities, as shown in FIG. 7A-7E.

More particularly FIG. 7A-E show Phase Sweep and Sine modulation comparison and performance at different fading rates for a phase modulation 2π sin (ωt/4). The choice of parameters is clarified in the mathematical expressions

FIG. 7A—no fading

$$10 Log ( {( 1 + Cos ( ω t ) )}^{2} + {Sin ( ω t )}^{2} )$$

$$10 Log ( {( 1 + Cos ( 2 π Sin ( \frac{ω}{4} t ) ) )}^{2} + {Sin ( 2 π Sin ( \frac{ω}{4} t ) )}^{2} ) \\$$

$$10 Log ( {( 1 + Cos ( ω t ) )}^{2} + {Sin ( ω t )}^{2} )$$

$$10 Log ( {( 1 + Cos ( 2 π Sin ( \frac{ω}{4} t ) ) )}^{2} + {Sin ( 2 π Sin ( \frac{ω}{4} t ) )}^{2} )$$

The graphs 7B-7E show amplitude against time for different fading rates:

FIG. 7B shows ω=0.05ω). FIG. 7C shows a ω=0.1ω and FIG. 7D shows ω=1.055ω. FIG. 7E shows ω=5.55ω.
The choice of parameters is clarified in the mathematical expressions

$$10 Log ( {( Cos ( ϖt ) + Sin ( ϖt ) Cos ( ω t ) )}^{2} + {( Sin ( ϖt ) Sin ( ω t ) )}^{2} )$$

$$10 Log ( {( Cos ( ϖt ) + Sin ( ϖt ) Cos ( 2 π Sin ( \frac{ω}{4} t ) ) )}^{2} + {( Sin ( ϖt ) Sin ( 2 π Sin ( \frac{ω}{4} t ) ) )}^{2} )$$

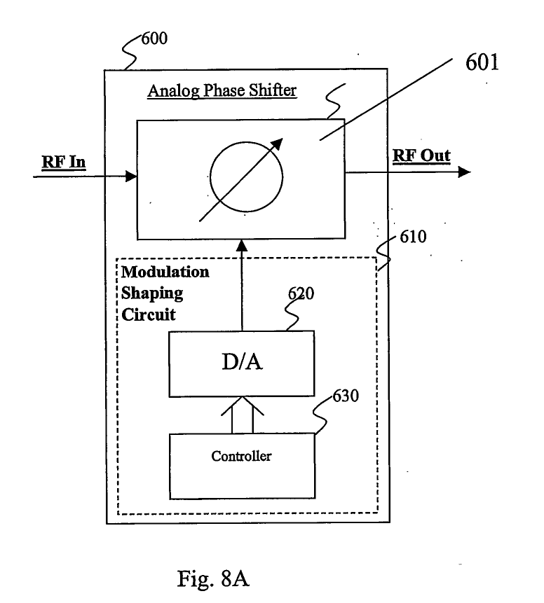

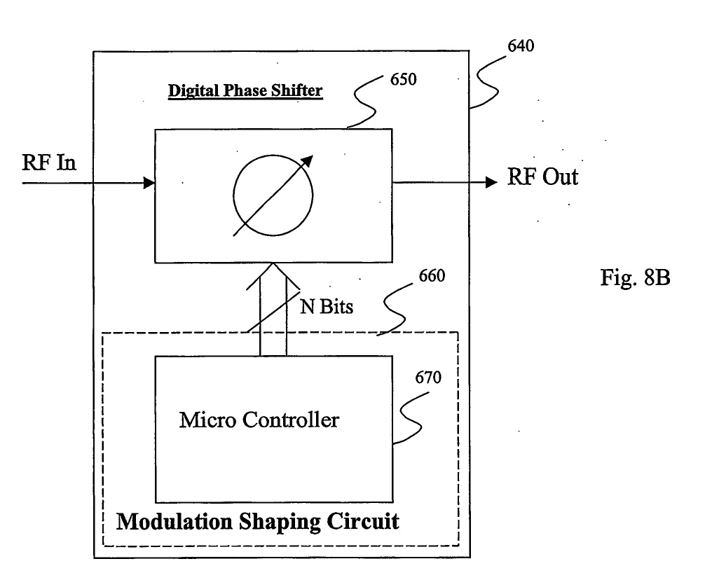

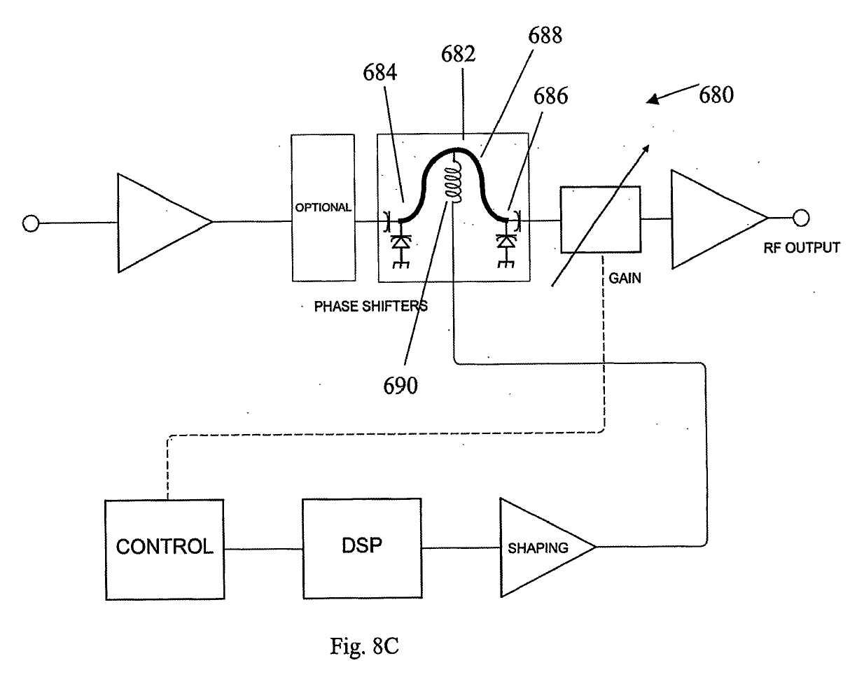

Reference is now made to FIG. 8A which is a simplified schematic diagram illustrating an analog phase shifter 600 for generating a phase sweep according to an embodiment of the present invention. Phase shifter 600 may correspond to phase sweeping unit 445 in repeater 404 of FIG. 6. Phase shifter 600 comprises a phase modulator 601 and a modulation shaping circuit 610. Modulation shaping circuit 610 includes a digital-to-analog (D/A) converter 620 and digital controller 630.

Digital controller 630 generates an optimal phase modulation and adaptively changes modulation parameters for optimal reception. Adaptive control of phase modulator 601 may depend on various parameters, such as the type of data transmission, channel characteristics, and modes of operation, for example speed of mobile terminal motion, type of receiver, length of the interleaver block and the like.

Reference is now made to FIG. 8B, which is a simplified schematic diagram that illustrates a digital phase shifter 640 for generating a phase sweep according to a further preferred embodiment of the present invention. Phase shifter 640 may correspond to phase sweeping unit 445 in repeater 404 of FIG. 6. Phase shifter 640 comprises a phase modulator 650 and a modulation shaping circuit 660. Modulation shaping circuit 660 includes a digital microcontroller 670. Microcontroller 670 performs similar functions to those performed by digital controller 630, as described above.

Analog and Digital phase modulators 601, 650 are components well-known in the microwave industry, but as far as is known have never been used in the RF field and certainly not in the field of phase modulation for transmit diversity. The analog Phase Modulator 601 is preferably implemented by using Varactor (voltage-variable Capacitor) diodes as a variable and controlled reflection network at the direct and coupled ports of a 3 dB Hybrid Coupler. The reflected signal is thus shifted in its phase by varying the control voltage for the varactor diodes. The Digital Phase Modulator is implemented by switching PIN diodes from their ON to OFF states. The PIN diodes are used in either a reflection network or within a transmission network where they switch the reactive load from Capacitive to Inductive behavior.

Reference is now made to FIG. 8C which is a simplified block diagram illustrating an exemplary analog phase shifter arrangement. In the arrangement 680 a phase shifter 682 comprises two varactor diodes 684 and 686 which are fed at the center of a stripline 688 through an RF Choke 690.

Downlink Diversity

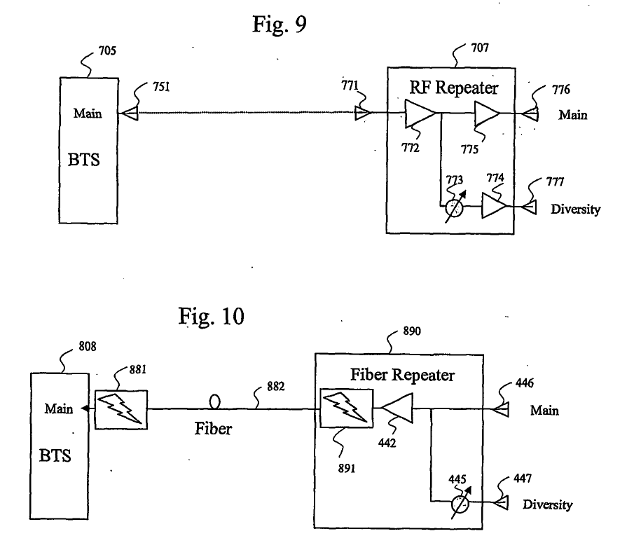

Reference is now made to FIG. 9, which is a simplified block diagram illustrating an RF repeater 707 that implements PSTD according to an embodiment of the present invention to provide non-linear phase modulation. The BTS 705 transmits a single downlink signal from base station antenna 751, which is received by a single RF repeater donor side antenna 771. The downlink signal, after being amplified by the LNA 772, is evenly split. One half is input to a phase sweeping unit 773 and then into a power amplifier 774. The other half of the signal is input directly to a power amplifier 775. From the respective power amplifiers the signals reach main 776 and diversity 777 antennas. The power amplifiers are configured so that both signals have about the same amplitude at the antennas 776, 777. Antennas 776, 777 are arranged so that the fading of the signals transmitted to the mobile unit are not correlated.

Phase sweeping unit 773 applies a phase sweep to the signal inputted to phase sweeping unit 773. Phase sweeping unit 773 may be adaptively controlled as described above regarding FIGS. 8A and 8B.

Fiber-Extended Repeater Embodiments with PSTD

A. Uplink Diversity Combining

Reference is now made to FIG. 10, which is a simplified block diagram illustrating a fiber optic repeater 890 according to an embodiment of the present invention. An optical fiber 882 relays RF signals between the repeater 890 and a BTS 808. The RF signals modulate an optical carrier wave. Main and diversity antennas 446, 447, phase sweeping mechanism 445, and amplifier 442 in repeater 890 are the same as those in FIG. 6 above and are given the same reference numerals, and provide selective diversity combining of the received (uplink) signals.

Repeater 890 includes a converter 891 coupled to amplifier 442 and optical fiber 882. Converter 891 converts an RF signal output by amplifier 442 into an optical signal for transmission across optical fiber 882. A converter 881 is coupled to optical fiber 882 and BTS 808. Converter 881 converts the transmitted optical signal back to an RF signal for further processing by BTS 808. Converter 891 may be external to repeater 890 in some embodiments, and converter 881 may be internal to BTS 808 in some embodiments.

In exemplary embodiments, each channel utilizes a separate fiber and converter, or an additional optical duplexer, such as a Wave Division Multiplexer (WDM).

B. Downlink Diversity

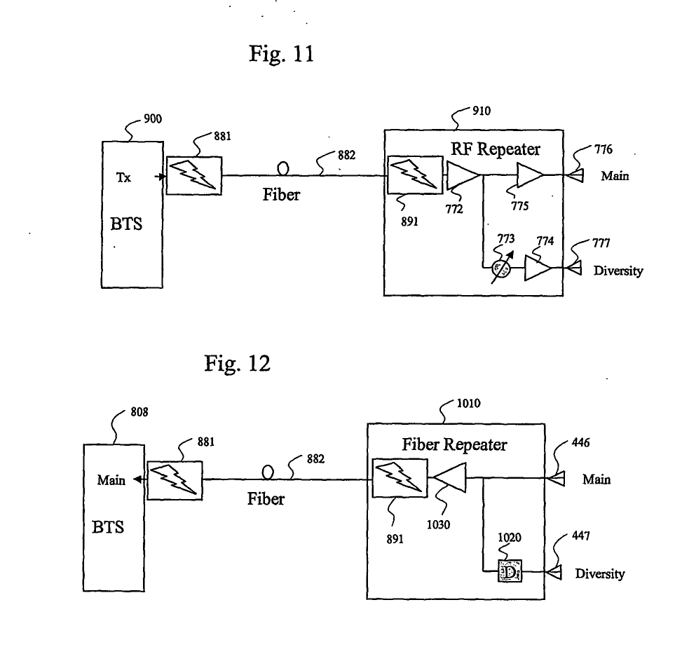

Reference is now made to FIG. 11, which is a simplified schematic diagram illustrating a fiber optic repeater 910 according to an embodiment of the present invention. In the repeater of FIG. 11, an optical fiber 882 relays RF signals between a BTS 900 and the repeater 910. The RF signals modulate the optical wave. Linear amplifier (LNA) 772, phase sweeping mechanism 773, amplifiers 774, 775, and main and diversity antennas 776, 777 in repeater 910 are the same as those described above relative to FIG. 9, are given the same reference numerals, and implement downlink diversity.

A converter 881 is coupled to BTS 900 and optical fiber 882. Converter 881 converts an RF signal into an optical signal for transmission across optical fiber 882. Repeater 910 includes a converter 891 coupled to optical fiber 882 and LNA 772. Converter 891 converts the transmitted optical signal back to an RF signal for further processing by LNA 772.

Fiber-Extended Repeater Embodiments with Time Delay Diversity

A. Uplink Diversity Combining

Reference is now made to FIG. 12, which is a simplified diagram illustrating a fiber optic repeater 1010 with a single fiber implementing uplink diversity combining with a delay unit, according to a preferred embodiment of the present invention. Repeater 1010 includes a delay unit 1020 in one of the uplink diversity signal paths. Uplink signals received by the remote diversity antennas 446, 447 are combined with equal gain after one of them has been delayed with the delay unit 1020. The combined signal is input to a common RF amplifier 1030, converted into an optical signal in the optical converter 891, and transmitted through an optical fiber 882 to the optical converter 881, which converts the optical signal back to RF for further processing by BTS 808.

B. Downlink Diversity

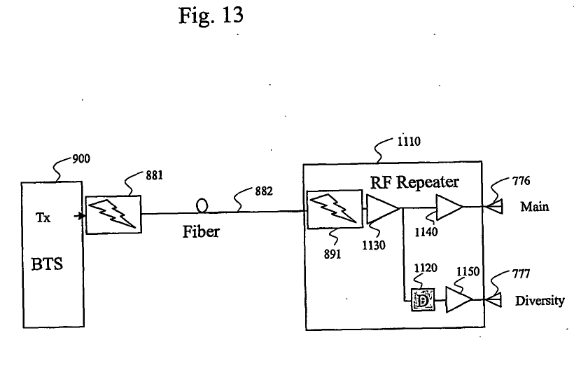

Reference is now made to FIG. 13, which is a simplified diagram that illustrates a fiber optic repeater 1110 providing downlink time delay diversity according to an embodiment of the present invention. Parts that are the same as in previous figures are given the same reference numerals and are not referred to again except as necessary for understanding the present embodiment. Repeater 1110 includes a delay unit 1120 in one of the downlink diversity signal paths. The BTS 900 transmits a single downlink RF signal, which is converted to an optical signal by RF fiber converter 881 and conveyed by an optical fiber 882 to an optical fiber converter 891 in repeater 1110. This downlink signal, after being converted back to an RF signal, is inputted to an LNA 1130 and split into two equal branches. One half is input to the time delay unit 1120 and then into a power amplifier 1150. The other half of the signal is input into another power amplifier 1140 so that both signals have about the same amplitude at the antennas 776, 777 of repeater 1110. Antennas 776, 777 are arranged so that the fading of the signals transmitted to the mobile unit are not correlated.

Exemplary implementations of delay units 1020, 1120 include lengths of conducting material, such as coaxial cable, strip line, microstrip, or a lumped delay line, as well as surface acoustic wave filters (SAWs).

Various Alternative embodiments are possible based on the above configurations. Some examples employ a low-power phase-modulated (PM) transmit diversity (TD) unit, located at the input to the high-power amplifiers in a repeater. The physical location could be either in the Interface and Control Unit or in the remote-antenna controller (RAC) disclosed in applications co-pending International Patent Application PCT/US02/38980, the contents of which are hereby incorporated by reference.

Transmit-diversity augmentation (TDA) of a legacy digital wireless communications BTS entails the addition of a second transmit path with the appropriate diversity-effect function as disclosed in the following International Patent Applications: IB00/01686, US01/02477, and IL03/00506, the contents of which are hereby incorporated by reference. The total radiated power need not be any higher than the original level, allowing the power level per path to be half the original power value.

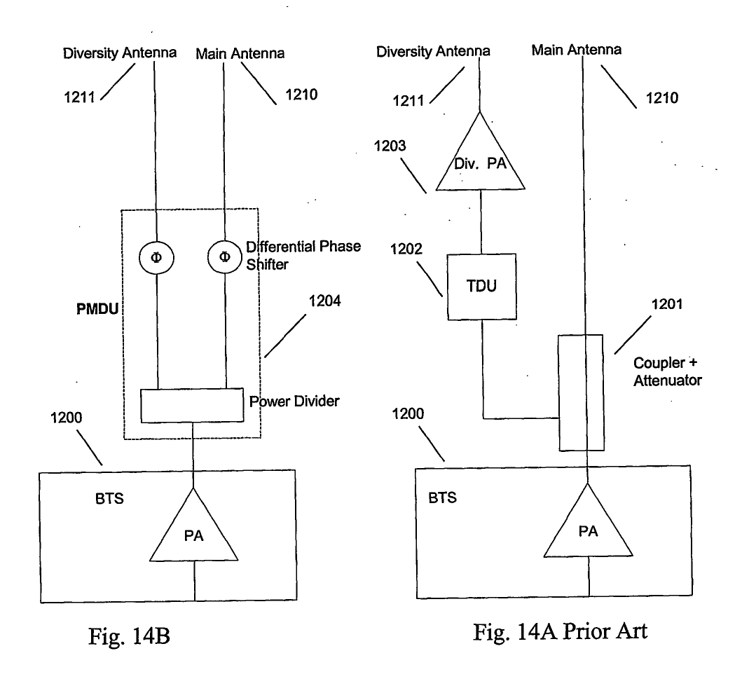

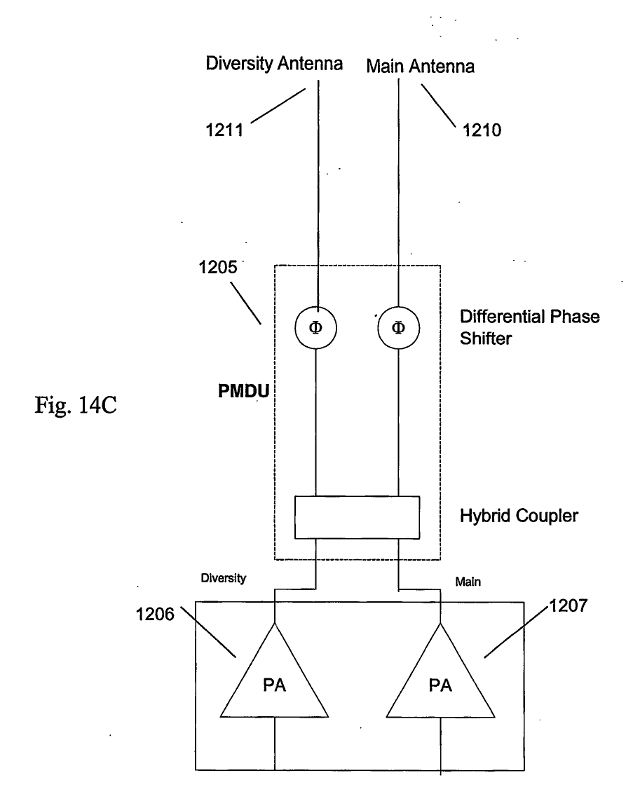

Reference is now made to FIG. 14A which illustrates a conventional transmit diversity augmentation scheme. A sample of a main transmit signal is coupled off the main line by Coupler-Attenuator 1201, processed to produce a diversity effect via transmit delay unit TDU 1202, and then amplified through a second diversity power amplifier 1203 which is added to the base station equipment 1200 just for this purpose. Each power amplifier may typically be operated at half the power level of the legacy amplifier which was employed prior to augmentation. As long as the diversity power amplifier is functionally limited to low-power, a cost-effective diversity power amplifier may be added to configure the TDA system for enhanced performance, while reducing system complexity and cost.

Reference is now made to FIG. 14B, which is a simplified schematic diagram illustrating how to apply non-linear phase modulation according to an embodiment of the present invention at high transmit power without additional amplification. The embodiment is useful in applying the present invention to provide a diversity capability to a legacy base station. In FIG. 14B, a TDA configuration without a second diversity power amplifier requires the diversity function PMDU 1204 to be located between the legacy power amplifier 1200 and the main antenna 1210 and the diversity antenna 1211. An alternative embodiment may employ only one Phase Shifter subsystem, for the Diversity path.

Reference is now made to FIG. 14C which illustrates an arrangement of the embodiment of FIG. 14B for a legacy BTS of a kind which is equipped for multicarrier operation, in this case two groups of carriers. In FIG. 14C some carriers are provided by power amplifier 1206, and other carriers are provided by power amplifier 1207. Main antenna 1210 and diversity antenna 1211 connections are driven by phase modulation diversity unit (PMDU) 1205.

It is noted that in both FIGS. 14B and 14C the two phase shifts in the differential phase shifter are by independent values φ₁ and φ₂ which are preferably not equal φ.

An embodiment of the phase-sweep PMDU for high-power systems may be specified to meet the requirements below:

Differential phase modulation range: 360°

Phase modulation rate: 100 Hz for a full rotation

Sweep mode: Continuous or in discrete steps no larger than 45° each

Insertion loss: 0.5 dB max.

Insertion loss modulation: 0.3 dB max over a full rotation

Average power handling: 50 Watts min.

Peak power handling: 1 kw min, 1 uSec duration, 0.01% duty cycle

Intermodulation products: −65 dBc max.

Mean time between failures (MTBF): 200,000 hours minimum.

There are several known technologies for implementing variable phase shifters, and these are listed below:

Electromechanical—switchable delay lines support discrete phase steps, but are expensive and not sufficiently reliable for fast and frequent switching.

PIN-diode-switched delay lines support discrete phase steps but are linearity-limited and excessively lossy.

Varactor phase shifters are not sufficiently linear and are excessively lossy.

Rotary-field ferrite phase shifters are typically relatively expensive and are excessively lossy.

A practical and available technology which is well known in the microwave field and which is suitable for implementing a high-power PMDU is a tri-plate (stripline) transmission line with variable dielectric loading. RF simulation results, coupled with available experience with stripline technology, indicate that an optimized stripline structure with a variable dielectric filling meets the above-presented RF performance specifications. The cost and MTBF parameters are strong functions of the dielectric material and of the rotation scheme.

The PMDU of the preferred embodiments thus employs a stripline with periodically-variable dielectric loading. The variable loading is applied synchronously to the main and diversity transmit paths, which may be formed by attaching a passive 3 dB power splitter or coupler. A coupler can be used as well as a splitter to form a second path since the coupler is able to pick up the signal at low level with little effect on the signal in the main path. The picked up signal is then modulated at low power and amplified. The coupler or splitter is preferably located at the legacy system power amplifier output. The effective dielectric constant imparted by the variable loading and the appropriate electrical length may then be tailored to provide a periodic 360° phase sweep. The variable loading is accomplished by engaging variable lengths of dielectric material into the stripline medium by the rotation of a direct-drive or belt-driving motor at e.g., in one embodiment 100 rotations per second.

In this embodiment, an alumina dielectric was selected for the extremely low dielectric loss coefficient. However, other low-loss dielectrics may alternatively be employed. Simulations of the performance of the stripline structure, coupled with other known fixed losses of the system, produce a maximum insertion loss of 0.5 dB and PM/AM of 0.2 dB over the full 360° phase.

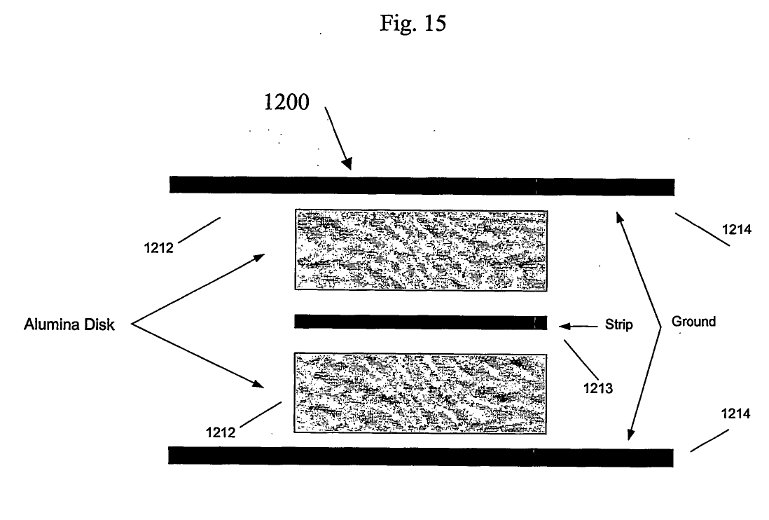

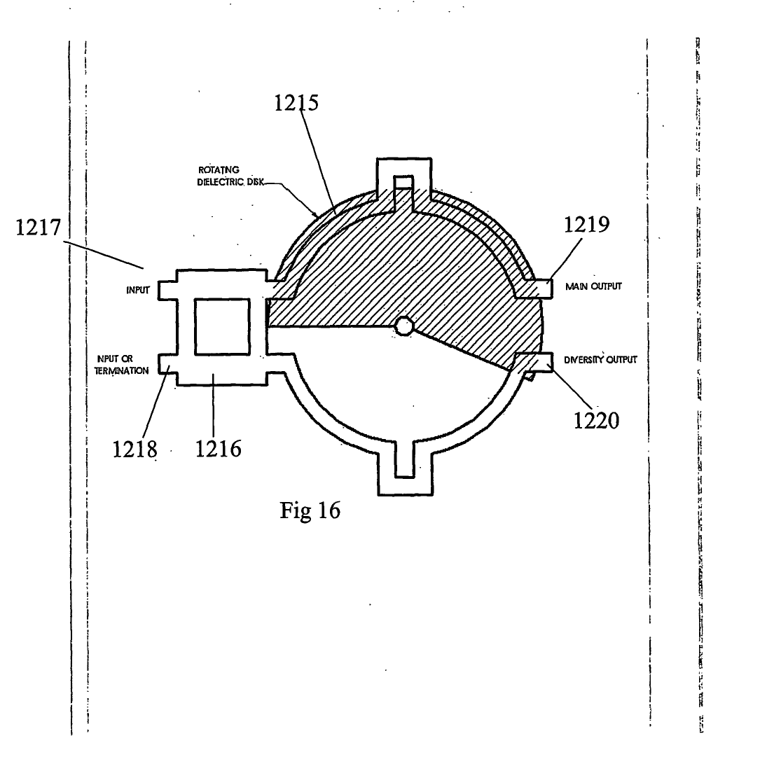

Reference is now made to FIG. 15, which illustrates a dielectrically loaded stripline implementation of the phase modulator according to a preferred embodiment of the present invention. In FIG. 15, a phase modulating element 1200 consists of a tri-plate transmission line and first and second movable dielectric plates 1212. The movable plates 1212 form the two outer layers of a sandwich including strip line 1213 surrounded by two ground lines 1214. The phase shift φ of a signal through a line of length L is given by the expression:
φ=2πfL/v,

where f is the signal frequency and v is the propagation velocity, and where v is determined by:
v=cₒ(εₒ/ε_{eff})^{1/2},

where cₒ is the vacuum velocity, εₒ is the vacuum dielectric constant and ε_{eff} is the effective dielectric constant of the propagation medium.

In this embodiment, φ is swept by varying Lᵣ, the portion of L which is loaded by ε_{eff}>εₒ, and Lₒ, the portion of L which is loaded by εₒ,

where L₀+L_{r.}=L=constant length.

In general, the higher ε_{eff}, the shorter L needs to be to cover a specified phase shift, Δφ. However, along with the propagation velocity, the characteristic impedance of the propagation medium, Z₁, also changes with ε_{eff} according to:
Z₁=Z₀(εₒ/ε_{eff})^{1/2},

where Z₀ is the characteristic impedance of the propagation medium in vacuum.

Clearly, if ε_{eff} is much larger than εₒ, and L is a significant portion of λ₀, the impedance mismatch of the line might be excessively high for the embedding environment. Therefore, to achieve a specified Δφ, L needs to be traded-off judiciously with the impedance mismatch, by the proper selection of ε_{eff} and Z₀.

The following description illustrates a particular embodiment of a variable phase shifter that covers a Δφvariation range of 180 in a 50 Ω system, at 2 GHz:

Select:
ε_{eff}=2 εₒ,
L=1.22λ₀ @2 GHz=1.22*150 mm=183 mm
Z₀=50 Ω*2^{1/2}=70.7 Ω.

State 1: L is unloaded, i.e., L=L₀

Then Δφ=1.22λ₀=440° and Z₁=Z₀=70.7 Ω−a 1.4:1 standing wave ratio.

State 2: L is fully loaded, i.e., L=Lᵣ

Then Δφ=1.22λ₀*2^{1/2}=620° and Z₁=Z₀/2^{1/2}=35 Ω−a 1.4:1 standing wave ratio.

Between State 1 and State 2, as Lᵣ increases and Lₒ decreases, the phase shifter sweeps a 180° range, providing a 440° to 620° phase sweep as the VSWR varies between 1:1 and 2:1.

In the Transmit Diversity Augmentation (TDA) system described in the above referred to International Patent Applications: IB00/01686, US01/02477, and IL03/00506, the output of the legacy amplifier is split into main and diversity transmit paths. To provide a swept 360° differential-phase between the two paths it suffices to rotate each path by 180° only, while offsetting the sweeps of the two paths by half a rotation. For a given selection of dielectric loading, such a differential scheme reduces the required total line length by approximately one half, compared with that of the single-path 360° phase shifter. The maximum insertion loss of the PMDU is reduced accordingly.

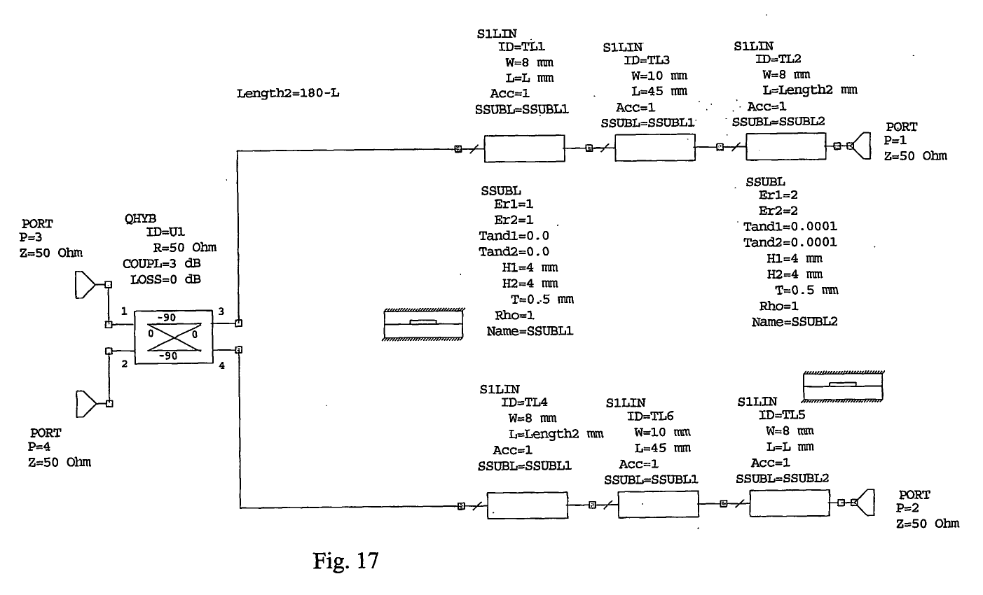

The PMDU is modeled for the 1.9 GHz PCS-Band implementation, as shown in FIGS. 16 and 17. The propagation medium is stripline 1213. In an embodiment, the strip width (W), strip thickness (T) and upper and lower-ground spacings, (H1, H2) are defined to provide Z₀=35 Ω when air-loaded and 62 Ω when dielectrically-loaded. The strip thickness is preferably 0.5 mm in order to provide rigidity. Rigidity is needed in some embodiments to prevent the strip from sagging towards the rotating Alumina disk.

A 50 Ω stripline hybrid coupler divides the output of the power amplifier equally between the main and diversity paths. Each path consists of a stripline arc, 183 mm long. The arcs are discontinued at the midpoint by a λ/4 long, U-shaped 50 Ω segment, which provides a convenient point of suspension. It also serves as a mismatch-reduction impedance-transformer between the two segments of each arc.

Two dielectric disks preferably form a sandwich with the arched portions of the phase shifter. The disks are made of high-grade Alumina, with a dissipation factor, δ, of e.g., 0.0001 in one embodiment. FIG. 15, discussed above, illustrates the stripline cross section. The Alumina disk 1212 preferably has a 2.4 mm thickness and is positioned equidistant from the strip and either ground in a 4-mm air gap. The series connection of a 2.4 mm thick Alumina with an intrinsic dielectric constant, εᵣ, of 10, and two air gaps, 0.8 mm above and below, produces ε_{eff}=2 εₒ which is highly insensitive to a lateral positioning error of the order of +/−0.3 mm in the gap.

Reference is now made to FIG. 16, which is a simplified diagram that illustrates the microwave circuit layout of a 1.9 GHz PCS-Band PMDU. An input signal supplied to input terminal 1217 is divided into two equal-amplitude main and diversity lines by a hybrid coupler 1216 which includes a termination port 1218. Phase shifter lines form arcs which are part of a first circle. The dielectric disks are shaped to alternately load the two lines every half revolution. The phase shifter lines cannot be laid-out as exact semicircles because of layout and coupling-related constraints. Therefore, to ensure a continuous differential-phase sweep, dielectric disks 1215 cover a physical sector slightly wider than 180°. Respective differential outputs 1219 for the Main antenna and 1220 for the Diversity antenna are provided, as shown in FIG. 16.

For each physical rotation, the differential phase of the main and diversity paths is swept by 360°. The PCS-Band PMDU, without any mechanical rotating mechanism, in one embodiment measures 230×200×20 mm. The rotating mechanism, which may include a motor and a transmission belt, is estimated for one embodiment to occupy 120×100×40 mm.

One PCS-Band PMDU embodiment was simulated, using MW Office RF CAD. The CAD model is illustrated in FIG. 17. Phase sweep was simulated by tuning the lengths Lᵣ and Lₒ=180 mm−Lᵣ of each line, from 0 to 180 mm.

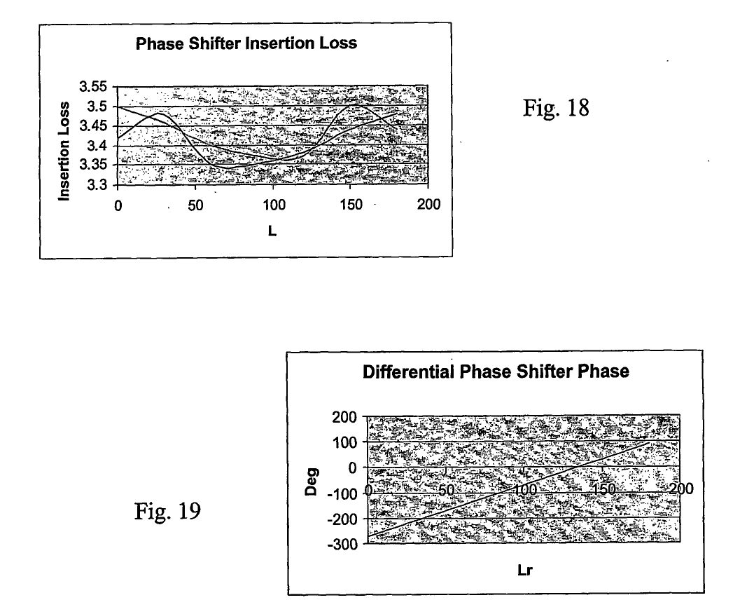

Reference is now made to FIG. 18, which is a graph that illustrates the phase shifter insertion loss of main and diversity paths, as a function of Lᵣ at a fixed frequency of 2 GHz for the model shown in FIG. 17. The computation of the simulated performance includes a 0.3 dB contribution from the fixed insertion loss of the stripline hybrid coupler and of the input and output coaxial connectors of the PMDU. FIG. 19 illustrates the computed relationship between Lr and the differential phase shift. The worst case return loss at the coupler input port is 14 dB.

In the same way that non-linear phase modulation can be applied to space diversity, so can it be applied to polarization diversity.

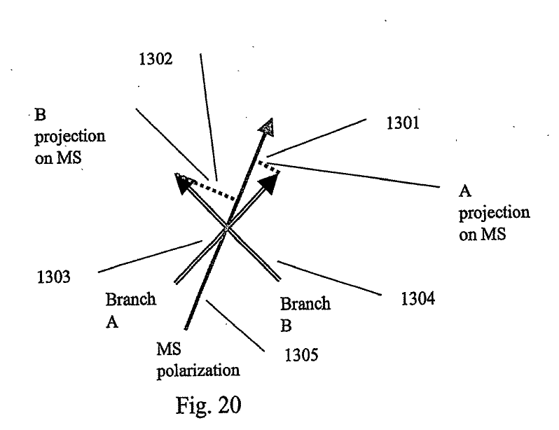

Reference is now made to FIG. 20, which is a phasor diagram which illustrates the system and method for using non-linear modulation to provide phase diversity. Let us say that phasor arrows 1303 and 1304 represent direct and diversity transmit signals. Arrow 1305 represents the polarization of the mobile station. Thus projections 1301 and 1302 are the only difference between the space and polarization diversity schemes. Namely, the only difference between a space and polarization diversity case is the inequality of projections 1301 and 1302. That is to say, in space diversity they are equal. in polarization diversity they depend on the orientation of the MS antenna. Here, the term projections is intended to indicate the respective magnitudes (resulting from the MS polarization vector) which are associated with the two respective transmitted branches 1303 and 1304. In the case in which the mobile unit (MS) is oriented in 3-dimensional space with instantaneous polarization 1305 such that the projections are the same, the effect of the Time Delay transmit diversity and of Phase Modulation transmit diversity, is the same for space and for polarization diversity. The equivalence in any other case comes when one of the branches is weighted accordingly. When observing the transmission vector in the polarization-modulated case, the ensuing polarization vector changes from linear to circular and then to orthogonal linear, and so on. However, as it is received by the MS, the projection is just the same. The inequality of the amplitude of received signals representing the two orthogonal slant branches in the polarization diversity case is a problem well known in the art, and co-pending International patent application IB01/01028, the contents of which are hereby incorporated by reference indicates solutions concerning equalizing of these branches. The solution discussed therein is an issue for Smart antenna systems, since any solution intended to meet this need has to apply individually to each respective MS.

An alternative embodiment of the present invention takes advantage of a known technique for providing high efficiency RF amplifiers. The known technique uses modulators which convert the input narrow-band signal into two constant-envelope, phase-modulated components, which, in-turn, feed two power amplifiers. These amplifiers may be operated in a high-efficiency switched-mode. The combined output of the two amplifiers provides a highly-linear version of the input signal. Another example for the use of a specialized modulator is described in U.S. Pat. No. 6,366,177 FIGS. 10 and 11 therein. In this example the modulator controls the instantaneous phase of the RF input signal to the high-efficiency non-linear power amplifier described therein.

Likewise the phase modulator function of the amplifier may be driven by an external signal, and thus there is provided a method of implementing the PMDU function of the present invention. Such an integrated modulator approach allows the modification of the FIG. 9 device of the present disclosure by replacing modulator 773 and amplifier 774 therewith.

The use of an external signal for phase modulation furthermore provides the opportunity for providing digital control of the phase of the integrated modulator.

An alternative embodiment uses a pair of high efficiency integrated amplifier modulators. A pair of signals then drive the two devices respectively to provide a differential phase shifter. Such a differential phase shifter can be used in the embodiment of FIG. 14B in which the RF power amplifier and high power PDMU as individual components may be replaced such a differential phase shifter.

The present embodiments are suitable for use with the wireless broadband for CDMA standard 1xEVDO, which is based on the Qualcomm HDR (high data rate) standards. The 1xEVDO system transmits at a rate dependent on the signal to noise ratio (SNR) for each particular MS. Any MS in a given location or traveling at a given speed affected by fading experiences a time varying SNR. In actual operation the time varying SNR changes at the rate of phase modulation as described herein. In one embodiment we use phase modulation with modulation parameters which depend on the number of users currently served by the BTS/sector (according to a predetermined table). In some cases, the phase modulation could be neutralized (no transmit diversity) when we have only one user served by the BTS, (since blind phase modulation transmit diversity could degrade performance for a single user).

The base station thus has an inherent capability to determine which MS in its area has the best SNR and thus can be assigned the highest transmission rates. Likewise the base station has the capability to identify the devices with poor SNR and supply them with lower data rates.

### Compact Passive Phase Sweeper

A further preferred embodiment of the present invention provides a passive Phase Sweeper, also referred to as a High Power PMDU. Its effectiveness in adding TD to cellular transmission depends on both low loss and an inexpensive and reliable implementation. A first implementation of the embodiment requires a high rotation speed of the dielectric disk, in the order of 3000 to 6000 RPM. An alternative implementation enables lower rotation speeds and a more compact design. A variety of wave-shapes, that is non-linear phase sweep patterns, is realized by appropriate shaping of the disk and the line patterns. Critical to its viability is the amount of insertion loss realizable within the structure, as the skilled person will appreciate.

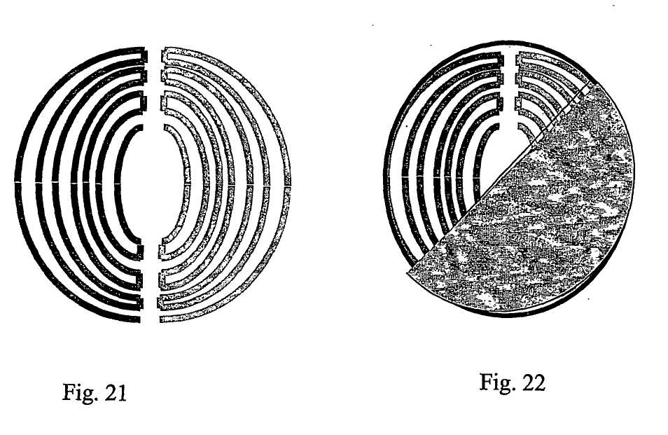

Reference is now made to FIG. 21, which shows a passive phase sweeper according to the present embodiment implemented with a spiral line pattern on the disc.

The spiral configuration shown in FIG. 21 is a common structure in Microwave lines and antennas. It allows for compact arrangement of long lengths of line. The length can thus be stretched 3 to 5 times, with a corresponding phase sweep rate per angle for the disk. The presence of dielectic-loaded sections in the line interlace does not change the accumulated phase. The skilled person is required to address impedance matching issues in the standard way, in order to make a specific implementation.

Reference is now made to FIG. 22, which illustrates a spiral configuration that is periodically-loaded by a rotating dielectric semi-disc to realize a swept-phase response.

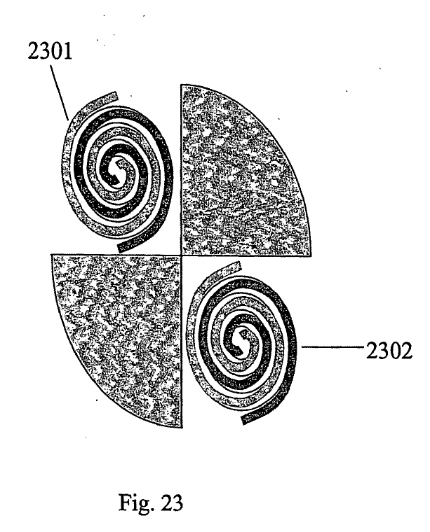

Reference is now made to FIG. 23, which illustrates bi-phase, multisector spirals. A bi-phase spiral is a conventional microwave structure used for antennas, delay lines etc and includes two spirals 2301, 2302 separated into two sectors. The number of spirals packed in any given radius can in fact be relativley large, thus extending the line length from x2 to over x5 within the same area. In a further embodiment, two bi-phase spirals in series can be configured to be scanned by a “butterfly” dielectric disk. The rate of rotation of the disk is thus reduced according to the line-length multiplier times 2.

Other Configurations

The number of sectors can be any even number and limited by the implementation of the spirals. Thus, instead of 4 sectors (two spirals) as in the figure, a 6 sector implementation, with three spirals, reduces the rotation rate to 2/3.

The shape of the spirals does not have to be circular, but may better fill in the sectors, to the limitations provided by the respective triangular arc within which each spiral fits. The shape of the dielectric disk may then be modified so as to have the desired phase sweep shape.

The critical criterion

The critical validity test is the implementation of the spirals in a very low-loss structure, in terms of conductor-, dielectric- and radiation-losses of the structure. The selection criteria of the materials and transmission medium are similar to hose applied to the PMDU embodiment in FIGS. 15 and 16.

While the invention has been described with reference to certain illustrated embodiments, the words which have been used herein are words of description, rather than words of limitation. Changes may be made, within the purview of the appended claims, without departing from the scope and spirit of the invention in its aspects. For instance, a repeater may incorporate both downlink and uplink embodiments.

Although the invention has been described with reference to particular structures, acts, and materials, the invention is not to be limited to the particulars disclosed, but rather extends to all equivalent structures, acts, and materials.

It is expected that during the life of this patent many relevant wireless communication devices and diversity based systems will be developed and the scope of the terms herein, particularly of the terms “cellular” and “diversity”, are intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. Apparatus for inserting transmit diversity into an RF or IF signal for transmission, comprising:
an RF splitter for splitting said signal for transmission into two signal parts, and
a non-linear phase modulator, associated with said RF splitter, for applying a non-linear phase modulation to one of said two signal parts, thereby to provide transmit diversity between said first signal part and said second signal part.

2. Apparatus according to claim 1, wherein said non-linear phase modulator comprises a transmission line with variable dielectric loading.

3. Apparatus according to claim 1, wherein said non-linear phase modulator is configured to provide a modulation being one of a group comprising sinusoidal, ramp, triangular and square wave modulation.

4. Apparatus according to claim 1, wherein said non-linear phase modulator is configured to provide two-step phase modulation.

5. Apparatus according to claim 1, wherein said non-linear phase modulator is configured to provide four-step phase modulation.

6. Apparatus according to claim 1, wherein said non-linear phase modulator is configured to provide eight-step phase modulation.

7. Apparatus according to claim 1, wherein said non-linear phase modulator comprises a delay line.

8. Apparatus according to claim 7, wherein said delay line is one of a group comprising: lengths of conducting material, lengths of coaxial cable, lengths of strip line, lengths of microstrip, a lumped delay line, surface acoustic wave filters (SAWs), a tri-plate transmission line with variable transmission loading, a disc constructed from a tri-plate transmission line with variable transmission loading, and a plurality of discs constructed from tri-plate transmission lines with variable transmission lines.

9. Apparatus according to claim 1, wherein said non-linear phase modulator comprises a tri-plate transmission line with variable transmission loading.

10. Apparatus according to claim 9, wherein said variable transmission loading is a periodically variable dielectric loading.

11. Apparatus according to claim 10, configured to apply said variable loading synchronously to respective paths of each of said first and second signal parts.

12. Apparatus according to claim 9, wherein tri-plate transmission line is configured with an effective dielectric constant and an electrical length to provide a periodic 360° phase sweep.

13. Apparatus according to claim 10, wherein said variable dielectric loading is provided using an alumina dielectric.

14. Apparatus according to claim 1, wherein said non-linear phase modulator comprises at least one rotatable disc with a spiral pattern of variable dielectric loading.

15. Apparatus according to claim 14, further comprising a motor for rotation of said disc.

16. Apparatus according to claim 1, wherein said non-linear phase modulator is combined with a power amplifier by feeding an RF signal to which said non-linear phase modulation has been applied, as an amplifier drive signal.

17. Apparatus according to claim 14, wherein said spiral pattern comprises a bi-phase spiral.

18. Apparatus according to claim 17, wherein said non-linear phase modulator further comprises a butterfly dielectric disc with two bi-phase spirals.

19. Apparatus according to claim 1, wherein said non-linear phase shifter is connected at a low power section of said apparatus and is followed by an amplifier for amplifying said signal part for transmission.

20. Apparatus according to claim 1, wherein said non-linear phase shifter is located at a high power section of said apparatus to apply a non-linear phase shift to said signal part at a transmission power level.

21. Apparatus according to claim 1 further comprising a signal combiner for combining said signal parts into a single signal for transmission in a single channel.

22. Apparatus according to claim 1, having a first link direction and a second link direction, said splitter and said non-linear phase modulator being for transmission in a single channel in said first link direction and a second non-linear phase modulator being followed by a combiner for transmission in said second link direction.

23. Apparatus according to claim 1, comprised into one of a group including a repeater, a cellular base station external upgrade, and a cellular base station extension.

24. Apparatus according to claim 22, comprising a repeater for extending the coverage of a base station or base station sector.

25. Apparatus according to claim 1, wherein said non-linear modulation provides space diversity.

26. Apparatus according to claim 1, wherein said non-linear modulation provides polarization diversity.

27. Apparatus according to claim 1, wherein transmission is in slots and wherein each slot is assigned to an individual recipient.

28. Apparatus according to claim 27, wherein said slot assignment is for high data rate transmission.

29. Apparatus according to claim 27, comprising bandwidth assignment logic configured such that a number of slots assigned to any given recipient is dynamically controlled in response to transmission quality associated with said recipient.

30. Apparatus according to claim 27, further comprising modulation parameter logic for dynamically altering parameters for said non-linear phase modulation in accordance with a number of recipients currently connected.

31. Apparatus according to claim 27, wherein said non-linear phase modulator is configured to suspend modulation when a number of currently connected recipients falls to one.

32. A phase modulating element for modulating an RF or IF frequency, comprising:
first and second movable dielectric plates,
first and second ground lines located in between said first and second movable plates, and
a strip line located in between said first and second ground lines,
said movable dielectric plates and said strip line forming a tri-plate variable dielectric transmission line to provide a non-linear modulation.

33. The phase modulating element of claim 32, configured as a rotatable disc.

34. The phase modulating element of claim 33, wherein variable dielectric regions are placed thereon as at least one spiral.

35. Method for inserting transmit diversity into an RF or IF signal for transmission, comprising:
splitting said signal for transmission into two signal parts, and
applying a non-linear phase modulation to one of said two signal parts, thereby to provide transmit diversity between said first signal part and said second signal part.

36. The method of claim 35, comprising carrying out said inserting in each of two transmission directions, and in one of said directions combining said first and second signal parts onto a single channel.
